(19) United States
(12) Patent Application Publication
(10) Pub. No.: US 2007/0140533 A1
(43) Pub. Date: Jun. 21, 2007

(54) INPUT DEVICE WITH A FINGERPRINT RECOGNIZING MECHANISM

(75) Inventors: Kuan-Hong Hsieh, Shenzhen (CN); Xiao-Guang Li, Shenzhen (CN); Robert Han Liu, Shenzhen (CN); Wen-Chuan Lian, Shenzhen (CN); Han-Che Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/557,084

(22) Filed: Nov. 6, 2006

(30) Foreign Application Priority Data
Dec. 20, 2005 (CN) 200510121021X

(51) Int. Cl. G06K 9/00

(52) U.S. Cl. 382/124

(57) ABSTRACT

An input device with a fingerprint recognizing mechanism is provided. The input device has a storage unit, a fingerprint input interface, and a microcontroller. The storage unit is for storing information, typically private, sensitive files/documents. Furthermore, the information is not allowable for access when the storage unit is in a locked state. The fingerprint input interface is for inputting fingerprint data of a fingerprint. The microcontroller includes a fingerprint identifying module and an unlocking module. The fingerprint identifying module compares the fingerprint data from the fingerprint input interface with predetermined fingerprint data, and generating an unlock signal if the fingerprint data match the predetermined fingerprint data. The unlocking module unlocks the storage unit in response to the unlock signal from the fingerprint identifying module, thereby enabling a computer system to access the information of the storage unit. A related method is also provided.

### BACKGROUND

1. Technical Field

The present invention relates to input devices and methods therefor, and particularly to an input device with a fingerprint recognizing mechanism and identification methods used in the input device.

2. General Background

Along with continual development of the information technology industry, computers have become adopted into everyday lives of people whether work related or personal related. Computer peripheral devices such as mice and memory devices have also become non-excludable products of computer systems.

When a user operates a computer to perform data processing, a mouse plays an important role when using a graphical user interface of the computer. Through an accurate cursor control provided by the mouse, the user can maneuver information on the screen performing actions such as, selection, drag, and execution, thereby performing data editing, data cutting or pasting, documents opening or closing, and so on.

In an unrelated aspect, it is also necessary to store various kinds of electronic data in peripheral devices. Therefore, data storage devices such as flash memories, electronic erasable programmable read-only memories (EEPROMs), or magnetic recording media were developed to store the various kinds of electronic data. For example, various kinds of memory cards allow users be able to conveniently exchange various kinds of files and documents between computers.

However, in prior arts, the cursor function of the mouse and the data storage function of the memory belong to separate peripheral devices. Nevertheless, the independent nature of these two functions may be troublesome to people, typically, a portable computer user who is often out of home or office. When portable computer users are not at home or the office, they have to carry many computer peripheral devices associated with the portable computer such as, for example, the mouse, the data storage device, and the like in addition to the portable computer. As a result, the more the computer peripheral devices needed, the higher the possibility portable computer users may forget to pack the peripheral devices. In other words, the separation of a mouse function and a storage function results in many inconveniences to people.

Therefore, a mouse capable of storing data, namely a combination of the conventional mouse and the conventional data storage device, has been introduced recently. This mouse can be used for data access when being used as a regular mouse. While this mouse is capable of precluding the above problem in portability, another problem is encountered in that, data stored in the mouse, are mostly private and sensitive information, however, has no mechanism to prevent unauthorized access to the data on the mouse capable of storing data.

What is needed, therefore, is an input device and a security method used therein, which is capable of preventing unauthorized access to the input device.

### SUMMARY

An input device with a fingerprint recognizing mechanism is provided. The input device has a coordinate output circuit, a storage unit, a fingerprint input interface, and a microcontroller. The coordinate output circuit is configured for outputting coordinates corresponding to a movement of the input device. The storage unit is for storing information. Furthermore, the storage unit is not allowable for access when it is in a locked state. The fingerprint input interface is for inputting fingerprint data of a fingerprint. The microcontroller is for outputting the coordinates from the coordinate output circuit to a computer system connected thereto. The microcontroller further includes a fingerprint identifying module and an unlocking module. The fingerprint identifying module is for comparing the fingerprint data received from the fingerprint input interface with predetermined fingerprint data that are authorized to access the storage unit, and generating an unlock signal if the fingerprint data received match the predetermined fingerprint data. The unlocking module is for unlocking the storage unit in response to the unlock signal from the fingerprint identifying module, thereby enabling the computer system to access the information of the storage unit.

A method used in an input device is also provided, wherein the input device has a storage unit and a fingerprint input interface, the fingerprint input interface being for inputting fingerprint data of a fingerprint. The method includes the steps of: (a) receiving the fingerprint data from the fingerprint input interface; (b) generating an unlock signal if the fingerprint data match predetermined fingerprint data that are authorized to access the storage unit; and (c) unlocking the storage unit according to the unlock signal, thereby enabling a computer system connected thereto to access the information of the storage unit.

Other advantages and novel features will be drawn from the following detailed description with reference to the attached drawing, in which:

### BRIEF DESCRIPTION OF THE DRAWINGS

FIG. 1 is an exemplary schematic diagram of a hardware infrastructure of an input device having a fingerprint recognizing mechanism in accordance with a preferred embodiment of the present invention; and

FIG. 2 is a flowchart of a preferred method for unlocking the storage unit of the input device of FIG. 1.

### DETAILED DESCRIPTION OF THE EMBODIMENT

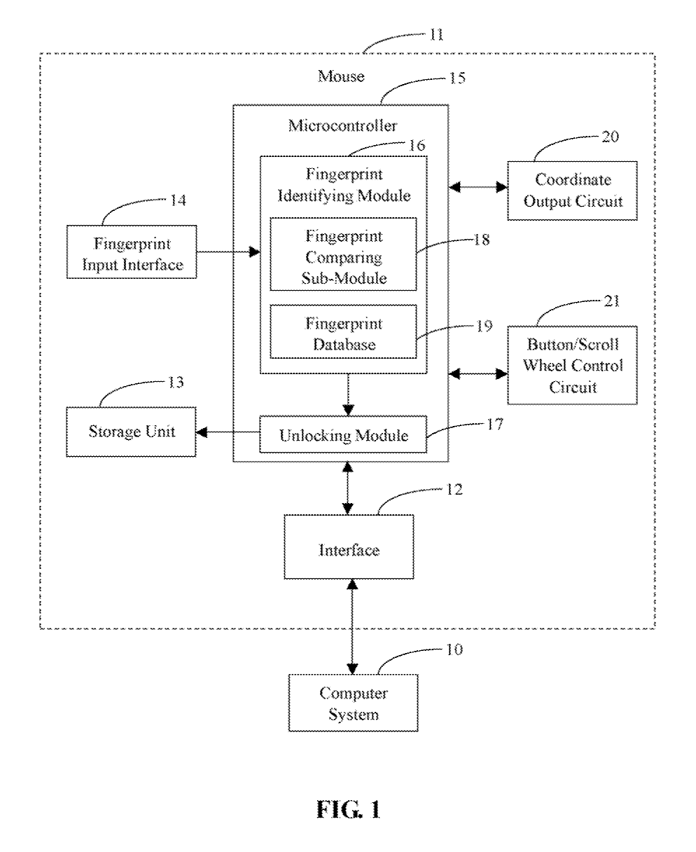

FIG. 1 is an exemplary schematic diagram of a hardware infrastructure of an input device in accordance with a preferred embodiment of the present invention. The input device 11 is a peripheral device, typically a pointing device such as, for example, a mouse, a joy stick, a track ball, etc, which not only enables control of a cursor on a display of a computer system 10 connected thereto, but also stores information. Furthermore, the input device 1 is configured with a security system, namely a fingerprint recognizing mechanism, for preventing unauthorized access to the stored information. In addition, due to the fingerprint recognizing mechanism, the input device 1 can prevent troubles of forgetting or leaking passwords, as compared to conventional password verification systems.

In this exemplary embodiment, the mouse is provided as an example. The mouse 11 has an interface 12, a storage unit 13, a fingerprint input interface 14, a microcontroller 15, a coordinate output unit 20, and a button/scroll wheel control circuit 21.

The interface 12 is configured for performing data communication between the mouse 11 and the computer system 10. Consequently, the interface 10 can be any appropriate communication media such as, for example, a Universal Serial Bus (USB) interface, a PS/2 (Personal System/2) interface, and so on.

The storage unit 13 is for storing information. The information includes various kinds of data, typically private files/documents. Furthermore, the storage unit 13 can be locked when a user of the mouse 11 is away from the mouse 11, thereby preventing unauthorized access to the information of the storage unit 13. Wherein, the lock technology for storages have been disclosed and described in prior arts, therefore, in-depth description of the lock technology is omitted herein.

The coordinate output unit 20 is configured for outputting coordinates corresponding to a movement of the mouse 11 to the microcontroller 15, which in turn transmits the coordinates to the computer system 10 through the interface 12. The button/scroll wheel control circuit 21 is configured for controlling operations of both buttons and scroll wheel of the mouse 11.

The fingerprint input interface 14, namely a fingerprint scanner, is configured for scanning a finger positioned thereon, extracting scanned fingerprint data of the finger scanned, and sending the scanned fingerprint data extracted to the microcontroller 15. The fingerprint scanner 14 can be an optical fingerprint scanner, a semiconductor fingerprint scanner, or any suitable type of fingerprint scanner. The scanned fingerprint data includes fingerprint identification points typically used in identifying a fingerprint

The microcontroller 15 further includes a fingerprint identifying module 16 and an unlocking module 17. The fingerprint identifying module 16 includes a fingerprint comparing sub-module 18 and a fingerprint database 19. The fingerprint database 19 is configured (i.e., structure and arranged) for storing corresponding data including predetermined fingerprint data of an owner(s) that is/are authorized to access the information of the storage unit 13. The fingerprint comparing sub-module 18 is configured for comparing the scanned fingerprint data received from the fingerprint input interface 14 with predetermined fingerprint data, and generating an unlock signal if the scanned fingerprint data received match the predetermined fingerprint data, otherwise, prompting information of an incorrect fingerprint. For example, the fingerprint comparing sub-module 18 prompts the information of the incorrect fingerprint on a display of the computer system 10, or triggers a buzzer (not shown) to generate a warning sound to output the information of an incorrect fingerprint.

The unlocking module 17 is configured for unlocking the storage unit 13 in response to the unlock signal from the fingerprint identifying module 16, thereby enabling an external device such as, for example, the computer system 10 to access the information of the storage unit 13.

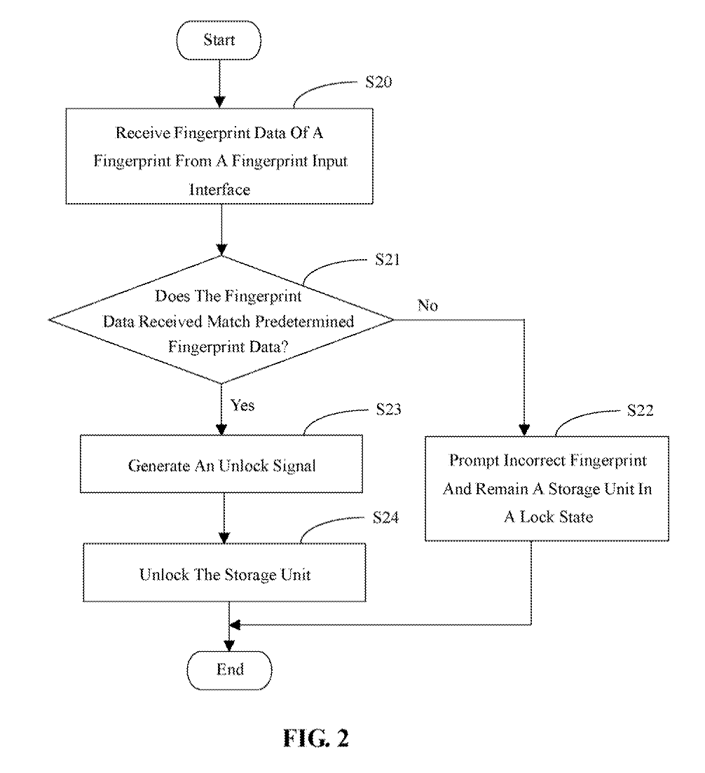

FIG. 2 is a flowchart of a preferred method for unlocking the storage unit 13 of the mouse 11 of FIG. 1. The fingerprint input interface 14 scans the fingerprint of the finger creating the scanned fingerprint data and sends the scanned fingerprint data to the fingerprint input interface 14.

In step S20, the fingerprint comparing sub-module 18 receives the scanned fingerprint data from the fingerprint input interface 14.

In step S21, the fingerprint comparing sub-module 18 compares the scanned fingerprint data received with the predetermined fingerprint data stored in the fingerprint database 19.

If the scanned fingerprint data received does not match the predetermined fingerprint data, in step S22, the storage unit 13 remains in a locked state, and the fingerprint comparing sub-module 18 prompts the information of an incorrect fingerprint on a display of the computer system 10, or triggers a buzzer to generating a warning sound to output the information of an incorrect fingerprint, and the procedure is finished.

If the scanned fingerprint data received matches the predetermined fingerprint data, in step S23, the fingerprint comparing sub-module 18 generates the unlock signal to the unlocking module 17.

In step S24, in response to the unlock signal, the unlocking module 17 unlocks the storage unit 13, thereby enabling the external device such as, for example, the computer system 10 to access the information of the storage unit 13, and the procedure is finished.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. An input device with a fingerprint recognizing mechanism, the input device comprising:
a coordinate output circuit configured for outputting coordinates corresponding to a movement of the input device;
a storage unit for storing information, wherein the storage unit is not allowable for access when it is in a locked state;
a fingerprint input interface for inputting fingerprint data of a fingerprint; and
a microcontroller for outputting the coordinates from the coordinate output circuit to a computer system connected thereto, the microcontroller further comprising:
a fingerprint identifying module, for comparing the fingerprint data received from the fingerprint input interface with predetermined fingerprint data that are authorized to access the storage unit, and generating an unlock signal if the fingerprint data received match the predetermined fingerprint data; and
an unlocking module, for unlocking the storage unit in response to the unlock signal from the fingerprint identifying module, thereby enabling the computer system to access the information of the storage unit.

2. The input device according to claim 1, wherein the fingerprint input interface is a fingerprint scanner.

3. The input device according to claim 2, wherein the fingerprint identifying module further comprises a fingerprint comparing sub-module and a database, the database being for storing the predetermined fingerprint data which are authorized to access the storage unit, and the fingerprint comparing sub-module being for comparing the fingerprint data received with the predetermined fingerprint data.

4. A method used in an input device, wherein the input device has a storage unit and a fingerprint input interface, the fingerprint input interface being configured for inputting fingerprint data of a fingerprint, the method comprising the steps of:
receiving the fingerprint data from the fingerprint input interface;
generating an unlock signal if the fingerprint data match predetermined fingerprint data that are authorized to access the storage unit; and
unlocking the storage unit according to the unlock signal, thereby enabling a computer system connected thereto to access the information of the storage unit.

5. The method according to claim 4, wherein the generating step further comprises the step of: providing a database for storing the predetermined fingerprint data; and comparing the fingerprint data with the predetermined fingerprint data.
